(19) United States
(12) Patent Application Publication
(10) Pub. No.: US 2014/0259830 A1
(43) Pub. Date: Sep. 18, 2014

(54) MULTI-PANEL SIGN SYSTEMS AND METHODS

(71) Applicant: 3M INNOVATIVE PROPERTIES COMPANY, Saint Paul, MN (US)

(72) Inventors: Sithya S. Khieu, Eden Prairie, MN (US); David C. May, Hudson, WI (US)

(73) Assignee: 3M INNOVATIVE PROPERTIES COMPANY, Saint Paul, MN (US)

(21) Appl. No.: 13/839,150

(22) Filed: Mar. 15, 2013

(51) Int. Cl. G09F 15/02; B29C 65/50

(52) U.S. Cl. CPC G09F 15/02; B29C 65/5057
USPC 40/594; 156/60

(57) ABSTRACT

A multi-panel sign system including first and second panels, and an adhesive-based fastener. The panels include a panel body and complimentary, first and second interlock structures. The panel body defines a front face for maintaining indicia, and first and second sides. The first and second interlock structures are located adjacent the first and second sides, respectively, and project opposite the front face. In an assembled stated, the first interlock structure of the first panel mechanically locks with the second interlock structure of the second panel to establish a interlocked joint, and the adhesive-based fastener is bonded to the first and second panels. The interlocked joint robustly maintains the panels relative to one another, whereas the adhesive-based fastener serves to prevent inadvertent sliding of the panels. Optically active sheeting can be applied to the front face of the panels, and desired indicia applied to the sheeting.

### BACKGROUND

The present disclosure relates to large signs, such as roadway guide signs. More particularly, it relates to systems and method for fabricating and installing large signs from two or more panels.

Signs are commonly used along roadways to display information to motor vehicle drivers and pedestrians. The term “sign” as used herein refers to a standalone article that conveys information, usually by means of alphanumeric characters, symbols, graphics, or other indicia, and that in use is mounted to an object such as a post, structure, bracket, wall, or similar body. Specific examples include signs used for traffic control purposes (STOP, YIELD, speed limit, informational, overhead highway sign, roadside marker, etc.). Guide signs are those signs used to direct road users along streets and highways, to inform them of intersecting routes, to direct them to cities, towns, villages, or other important destinations, to identify nearby rivers and streams, parks, forests, and historical sites, and generally to give such information as will help them along their way in the most simple, direct manner possible.

Many signs include optically active (e.g., reflective or retroreflective) sheeting that has characters or images printed or placed thereon. The characters or images provide information of interest, and the retroreflective sheeting allows the information to be vividly displayed at night. The term “retroreflective” as used herein refers to the attribute of reflecting an obliquely incident light ray in a direction antiparallel to its incident direction, or nearly so, such that it returns to the light source or the immediate vicinity thereof. Retroreflective sheeting has the ability to return a substantial portion of incident light in the direction from which the light originated. Light from motor vehicle headlamps is retroreflected by the signs, allowing information to be read more easily by passing motorists.

In many instances, guide signs or other signs (e.g., billboards) desirably provide an enlarged display surface area to allow presentation of information in large format. As a point of reference, traffic control regulations conventionally require that word messages displayed on a roadway sign provide one inch of letter height for every 30 feet of required legibility distance. Required legibility distance is a function of the expected speed of traffic; the faster the expected speed, the larger the letters must be. For example, a guide sign to be located alongside a road where traffic is regulated to 35 mph is typically required to employ letters of at least 5 inches in height to effectively give the person driving time to read the sign before passing it. Symbols (e.g., directional arrows) must also be quite large, and sufficient spacing must be provided between lines of information. To meet these needs, many guide signs and other signs commonly provide rectangular display surface areas with heights in excess of two feet and lengths in excess of 10 feet. For example, one typical large guide sign format has a display surface area height on the order of 14 feet and a length on the order of 40 feet.

The large guide signs described above are typically designed and manufactured in sections. In general terms, the desired display surface area is created by assembling two (or more) standard sized panels to one another. Each of the panels provides a relatively flat front surface; when the two (or more) panels are assembled to one another, the corresponding front surfaces are aligned and combine to collectively generate the enlarged display surface area of the resultant sign. Because guide signs and other signs are used outdoors and thus exposed to harsh environmental conditions (wind, inclement weather, etc.), the panels must be structurally robust, as must the assembly between individual panels. Moreover, the sign must be robustly erected to a conventional support structure, such as an I-beam type metal post. To meet these and other criteria, the panels used for creating large guide and other signs are typically extruded metal (e.g., aluminum) and form a panel body defining the flat front surface, along with bracket assemblies projecting rearwardly from opposite sides of the panel body. Each bracket assembly includes a relatively flat brace extending generally perpendicular to the panel body, and a bracket extending from the brace opposite the panel body. Two panels are arranged one above the other such that a brace of the upper panel abuts the brace of the lower panel. A number of stitch bolts or similar mechanical fasteners are then employed to attach the corresponding braces, and thus panels, to one another (e.g., conventionally, a series of apertures are formed in each brace for receiving the stitch bolts).

Commensurate with previous explanations, optically active sheeting can be applied to the front surface of each panel prior to panel-to-panel mounting. Once the panels are assembled, desired indicia (e.g., letters, numbers, symbols or other images) is/are then prepared and applied to the collective display surface. In many instances, portions of the indicia will overlap the panel bodies of two (or more) of the panels (e.g., due to a desired large font size, letters of a word extend over two panels). Under these circumstances, the portion of the indicia that does not contact either panel is cut with a knife and in some cases is wrapped around the corresponding panel body side. As result, the indicia is divided into two indicia segments; a first segment carried by the first panel and a second segment carried by the second panel. The first and second segments are registered relative to one another to collectively form the desired, complete image.

Following assembly and labeling, the completed multi-panel sign is delivered to the installation site. Depending upon an overall size and available resources, the sign can be shipped in completed form and installed upon arrival. While this methodology is well-accepted, certain problems exist. The sign will inevitably be subjected to jostling during delivery. While the stitch bolt mountings described above satisfactorily maintain connection between the panels, some panel-to-panel shifting invariably occurs. This shifting, in turn, will move the indicia carried by each panel out of registration or alignment with one another, resulting in an unsatisfactory appearance. The installers can attempt to loosen the stitch bolts and re-align the panels relative to one another, but this is a time consuming and labor-intensive process. Along these same lines, for some very large signs, the panels (labeled with desired indicia) are delivered to the installation site unassembled. The installers are required to arrange the panels relative to one another in a desired manner, and then fasten adjacent panels to one another with stitch bolts. Again, this can be a very difficult task. Moreover, following installation, wind, snow, rain and other outdoor environmental events will impact the sign over time, possibly causing panel-to-panel shifting to undesirably occur.

In light of the above, a need exists for improved multi-panel signs and methods of preparing such signs that facilitate rapid and secure assembly.

### SUMMARY

Some aspects of the present disclosure relate to a multi-panel sign system including first and second panels, and an adhesive-based fastener. Each of the panels include a panel body and complimentary, first and second interlock structures. The panel body defines a substantially planar front major face for maintaining signage indicia, and defines opposing, first and second sides. The first and second interlock structures are located adjacent the first and second sides, respectively, and project in a direction opposite the front face. The system is configured to provide a disassembled state and an assembled state. In the disassembled state, the panels are separated from one another. In the assembled stated, the first interlock structure of the first panel mechanically locks with the second interlock structure of the second panel to establish an interlocked joint. Further, the adhesive-based fastener is adhesively bonded to the first and second panels. With this configuration, the interlocked joint robustly maintains the panels relative to one another. The adhesive-based fastener is not a load bearing component of the assembly, but serves to prevent inadvertent sliding of the panels relative to each other and can prevent disengagement of the interlocked joint. In some embodiments, the interlock structures are configured such that prior to assembly, the adhesive-based fastener is adhered to the second interlock structure and provides an exposed adhesive face; further, engagement of the first and second interlock structures occurs in a direction substantially parallel to a plane of the exposed adhesive, promoting complete contact between the first panel and the exposed adhesive. In other embodiments, an optically active sheeting (e.g., retroreflective sheeting) is applied to the front major face of each of the panels, and desired indicia is formed on the sheeting. In yet other embodiments, the optically active sheeting is imaged (e.g., screen printing, direct-apply copy, digital printing, etc.) with the desired indicia and is pre-fabricated onto a carrier structure, such as a thin aluminum or plastic sheet, to form an overlay. The sign overlay can then be adhesively (e.g., pressure sensitive adhesives or tapes) or mechanically (e.g., rivets or bolts) secured to the front face of the assembled panels.

Other aspects in accordance with principles of the present disclosure are directed toward a method of fabricating a multi-panel sign. The method includes receiving the first and second panels described above. The first and second panels are interlocked to one another, including the first interlock structure of the first panel mechanically engaged with the second interlock structure of the second panel. Further, an adhesive-based fastener is adhesively bonded to the first and second panels such that the adhesive-based fastener impedes sliding of the first panel relative to the second panel. A first indicia segment is disposed over the front major face of the first panel, and a second indicia segment is disposed over the front major face of the second panel. In this regard, the first indicia segment is registered with the second indicia segment to collectively form an indicia item. The interlocked first and second panels are constrained from movement relative to one another, such as during delivery of the sign to an installation site, thus maintaining the indicia item.

### BRIEF DESCRIPTION OF THE DRAWINGS

FIG. 1A is a simplified, exploded view of a multi-panel sign system in accordance with principles of the present disclosure;

FIG. 1B is a front plan view of panel components of the system of FIG. 1A mounted to one another and forming a sign blank;

FIG. 1C is a front plan view of a complete sign fabricated from the system of FIG. 1A;

FIG. 2 is a perspective view of a panel in accordance with principles of the present disclosure and useful with the system of FIG. 1A;

FIG. 3 is a side view of the panel of FIG. 2;

FIGS. 4A-4D are enlarged side views of portions of the panel of FIG. 3;

FIG. 5A is an enlarged side view illustrating an interlocked joint formed by two of the panels of FIG. 3;

FIG. 5B illustrates assembly of the joint of FIG. 5A;

FIG. 6 is a simplified end view of an adhesive-based fastener useful with the system of FIG. 1A;

FIG. 7A is an enlarged side view illustrating the interlocked joint of FIG. 5A in combination with the adhesive-based fastener of FIG. 6;

FIG. 7B illustrates assembly of the joint of FIG. 7A;

FIG. 8A is a side view of a panel assembly useful with multi-panel sign systems and methods of the present disclosure;

FIG. 8B is a front view of a sign blank formed by the panel assemblies of FIG. 8A;

FIGS. 8C and 8D are front views of multi-panel signs fabricated in accordance with principles of the present disclosure;

FIG. 9A is a side view of two of the panel assemblies of FIG. 8A mounted to one another along with the adhesive-based fastener of FIG. 6;

FIG. 9B is an enlarged view of a portion of the assembly of FIG. 9A;

FIGS. 9C and 9D illustrate multi-panel sign fabrication methods in accordance with principles of the present disclosure;

FIG. 10A is a front plan view of a multi-panel sign in accordance with principles of the present disclosure installed at an installation site; and

FIG. 10B is an enlarged rear view of the installation of FIG. 10A.

### DETAILED DESCRIPTION

One embodiment of a multi-panel sign system 20 in accordance with principles of the present disclosure in shown in simplified form in FIG. 1A and includes a plurality of panels 22 (referenced generally), a plurality of adhesive-based fasteners 24, and indicia 26. Details on the various components are provided below. In general terms, however, the panels 22 incorporate complimentary interlock structures. In the disassembled state of FIG. 1A, the panels 22 are separated from one another. In the assembled state of FIG. 1B, adjacent ones of the panels 22 are robustly mounted to one another via the complimentary interlock structures to collectively form a sign blank 28. At least one of the adhesive-based fasteners 24 (FIG. 1A) is secured between adjacent ones of the panels 22 to impede sliding of the panels 22 relative to one another. As reflected by the completed sign 30 of FIG. 1C, then, the indicia 26 carried by each of the panels 22 can be registered across two (or more) of the panels 22 and will remain aligned during handling of the completed sign 30. As a point of reference, FIG. 1C provides coordinate designations used throughout this disclosure, including a length direction X and a height direction Y. A depth direction Z (not shown) is into a plane of the page of FIG. 1C.

In some embodiments, two or more or all of the panels 22 have an identical construction, one embodiment of which is shown in greater detail in FIG. 2. The panel 22 can be an integral, homogenous structure (e.g., extruded metal such as aluminum) and forms or defines a panel body 40 and complimentary, first and second interlock structures 42, 44 (referenced generally). The interlock structures 42, 44 project from the panel body 40 and are configured to facilitate assembly with the complimentary interlock structure provided with a second panel (e.g., the first interlock structure 42 of the panel 22 can engage (or interlock) with the second interlock structure 44 provided with a second panel (not shown)). In some embodiments, the panel 22 optionally includes one or more support struts 46.

The panel body 40 defines opposing, front and rear major faces 50, 52 (the rear major face 52 being referenced generally in FIG. 2). The front major surface 50 is substantially flat or planar (e.g., within 10% of a truly flat surface), and can have the rectangular shape shown. A perimeter of the panel body 40 defines opposing, first and second sides 54, 56, and opposing, first and second ends 58, 60. A distance between opposing ends 58, 60 in the length direction X can be viewed as a length of the panel body 40, and a distance between the opposing sides 54, 56 in the height direction Y as the height. A major plane P (referenced generally) of the panel body 40 serves as a point of reference for other components of the panel 22 and is defined by the substantially planar front major face 50 as a plane in the length X and height Y directions. Finally, a thickness of the panel body 40 is defined in the depth direction Z. The first and second interlock structures 42, 44 are located adjacent the first and second sides 54, 56, respectively, each generally project from the rear major face 52 (e.g., in the depth direction Z, away from or opposite the front major face 50), and in some embodiments extend along an entirety of the corresponding side 54, 54 (e.g., FIG. 2 illustrates the second interlock structure 44 as extending to the opposing ends 58, 60). With these designations in mind, the panel body 40 can be elongated having a height on the order of 6 inches, 12 inches, 18 inches, etc.; a length on the order of 2 feet, 10 feet, 18 feet, 36 feet, etc.; a thickness on the order of 0.125 inch, 0.5 inch, etc.

The interlock structures 42, 44 each form one or more features that facilitate engagement there between. For example, FIG. 3 illustrates the first interlock structure 42 as including a first finger 70, a first slot 72, an optional second finger 74 and an optional second slot 76. In some embodiments, the second finger 74, the second slot 76 and a portion of the first slot 72 are defined by framework 78. The first finger 70 and the framework 78 project from the rear major face 52 at a location adjacent to, but spaced from, the first side 54. For example, the first finger 70 is located closer to the first side 54 than the framework 78, but is spaced from the first side 54 in a direction of the second side 56 (i.e., the height direction Y). For reasons made clear below, extension of the panel body 40 beyond the first interlock structure 42 (i.e., region of the panel body 40 between the first finger 70 and the first side 54) defines an overhang 80 that is sized and shaped to interface with corresponding features of the second interlock structure 44.

The first finger 52 is show in greater detail in FIG. 4A and extends from the rear major face 52 in a generally perpendicular manner relative to the major plane P of the panel body 40. For example, the first finger 70 is defined by opposing, leading and trailing surfaces 90, 92, and terminates at a tip 94 opposite a base 96 defined at the rear major face 52. The leading and trailing surfaces 90, 92 can be non-parallel relative to one another in extension from the rear major face 52 (e.g., the first finger 70 can have a slightly tapering thickness in extension to the tip 94), defining a size a shape configured to mate with a corresponding feature provided with the second interlock structure 44 (FIG. 3) as described below. Further, one or both of the leading and trailing surfaces 90, 92 can be substantially perpendicular to the major plane P of the panel body 40 (e.g., within 5 degrees of a truly perpendicular relationship). For example, with the configuration of FIG. 4A, the leading surface 90 is substantially perpendicular to the major plane P, whereas the trailing surface 92 establishes a plane that is non-perpendicular to the major plane P thus generating the tapered shape for the first finger 70.

Returning to FIG. 3, the framework 78 of the first interlock structure 42 can include a leg 100, the second finger 74, and a clip assembly anchor 102. The leg 100 extends from the rear major face 52 generally in the depth direction Z. In this regard, the leg 100 forms or defines opposing, first and second side faces 104, 106. The second finger 74 projects from the leg 100 opposite the rear major face 52. Finally, the bracket 102 extends from the second side face 106 at a location spaced (in the depth direction Z) from the rear major face 52.

As best shown in FIG. 4A, the first finger 70 and the leg 100 combine to define the first slot 72. More particularly, the first slot 72 is formed between the trailing surface 92 of the first finger 70 and the first side face 104 of the leg 100. The first slot 72 has an open end 110 at the tip 94, and terminates at a closed end 112 that is formed, for example, at or by the rear major face 52. In this regard, a surface of the first slot 72 from the open end 110 to the closed end 112 can be substantially perpendicular to the major plane P of the panel body 40 (e.g., within 5 degrees of a truly perpendicular relationship) for reasons made clear below. The first slot 72 is sized and shaped in accordance with a corresponding feature of the second interlock structure 42 (FIG. 3), and can taper in width (i.e., the height direction Y) from the open end 110 to the closed end 112. For example, with the configuration of FIG. 4A, the first side face 104 of the leg 100 establishes a plane (at least in a region of the first slot 72) that is substantially perpendicular to the major plane P of the panel body 40 (e.g., within 5 degrees of a truly perpendicular relationship), and the trailing surface 92 of the first finger 70 is non-perpendicular to the major plane P as described above.

Returning to FIG. 3, the leg 100 projects beyond the first finger 70 (in the depth direction Z) to further space the second finger 74 and the bracket 102 away from the rear major face 52. With additional reference to FIG. 4B, the second finger 74 projects from the leg 100 (and alternatively can be viewed as a continuation of the leg 100) in the depth direction Z and is substantially perpendicular (e.g., within 5 degrees of a truly perpendicular relationship) to the major plane P of the panel body 40. Stated otherwise, the second finger 74 defines a base 120 at the leg 100, and extends to a tip 122. Extension of the second finger 74 from the base 120 to the tip 122 forms leading and trailing surfaces 124, 126; at least one of the surfaces 124, 126 is substantially perpendicular to the major plane P of the panel body 40. With the embodiment of FIG. 4B, the leading surface 124 establishes a plane that is substantially perpendicular to the major plane P. The second finger 74 is sized and shaped to interface with a corresponding component of the second interlock structure 44 (FIG. 2), and can taper in thickness (i.e., the height direction Y) from the base 120 to the tip 122. More particularly, the trailing surface 126 extends at an angle that is non-perpendicular to the major plane P.

The clip assembly anchor 102 can assume a variety of forms and in some embodiments is akin to clip assembly anchors conventionally employed for mounting guide signs to an I-beam via a standard clip assembly. Thus, the clip assembly anchor 102 can include opposing, first and second bracket segments 130, 132 that define a trough 134 configured for assembly to an I-beam (for example by bolts or other clip assembly components captured within the trough 134). In some embodiments, the clip assembly anchor 102 extends beyond (in the depth direction Z) the tip 122 of the second finger 74.

Regardless of the exact configuration of the clip assembly anchor 102, the second slot 76 is formed by the framework 78, for example between the trailing surface 126 of the second finger 74 and a side surface 136 of the first bracket segment 130. The second slot 76 is sized and shaped in accordance with a corresponding feature of the second interlock structure 44, and can be viewed as having an open end 140 opposite a closed end 142. The second slot 76 can taper in width (i.e., the height direction Y) from the open end 140 to the closed end 142. In some embodiments, the second slot 76 is arranged such that a surface thereof is substantially perpendicular (i.e., within 5 degrees of a truly perpendicular relationship) to the major plane P of the panel body 40 for reasons made clear below. For example, with the configuration of FIG. 4B, the side surface 136 of the bracket segment 130 (at least in a region of the second slot 76) is substantially perpendicular to the major plane P of the panel body 40, whereas the trailing surface 126 of the second finger 74 establishes a plane that is non-perpendicular with the major plane P.

With specific reference to FIG. 3, the second interlock structure 44 is configured in accordance with several of the features described above with respect to the first interlock structure 42 (e.g. the first finger 70, the first slot 72, the second finger 74 and/or the second slot 76). For example, the second interlock structure 44 can include a platform 150, a first rail 152, a first channel 154, an optional second rail 156 and an optional second channel 158. In some embodiments, the rails 152, 156 and the channels 154, 158 are defined by framework 160 extending from the platform 150. The second interlock structure 44 is located adjacent, but spaced from, the second side 56. For example, the platform 150 projects away from the second side 56 in the height direction Y (i.e., in a direction opposite the first side 54); the framework 160, in turn, projects from the platform 150 opposite the first side 54 (e.g., the first rail 152 is spaced from the second side 56 in the height direction Y).

With additional reference to FIG. 4C, the platform 160 defines opposing, exterior and interior surfaces 170, 172. The exterior surface 170 is generally sized and shaped in accordance with the overhang 80 (FIG. 4A) as described below, and in some embodiments is substantially flat or planar (e.g., within 10 percent of a truly flat surface). Further, the exterior surface 170 defines a plane that is substantially parallel with the major plane P of the panel body 40 (e.g., within 5 degrees of a truly parallel relationship). However, the platform 160 is spaced from a plane of the front major face 50 in the depth direction Z, such that an off-set 0 is defined between the platform exterior surface 170 and the panel body front major face 50. A depth of the off-set 0 (in the depth direction Z) is greater than a thickness of the panel body 40, for example by a distance sized to receive the adhesive-based fastener 24 (FIG. 1A). For example, the exterior surface 170 can be offset from the rear major face 52 in the depth direction Z by a distance commensurate with a nominal thickness of the adhesive-based fastener 24 for reasons made clear below. In some embodiments, a lip 174 can be formed along the exterior surface 170 immediately adjacent the first channel 154. A width of the platform exterior surface 170 (i.e., in the height direction Y) between the panel body second side 56 and the lip 174 can be commensurate with a width of the adhesive-based fastener 24.

The framework 160 extends from the platform 150 in a direction generally away from the panel body 40, and can include the first rail 152, a shoulder 180, a leg 182, the second rail 156, and a clip assembly anchor 184. With specific reference to FIG. 4C, the first rail 152 extends from a base 190 defined at the leg 182 (e.g., the first rail 152 can alternatively be viewed as a continuation of the leg 182) to a tip 192 opposite the base 190, and defines opposing, leading and trailing surfaces 194, 196. In general terms, extension of the first rail 152 to the tip 192 is substantially perpendicular with the major plane P of the panel body 40 (e.g., within 5 degrees of a truly perpendicular relationship). For example, one or both of the leading and trailing surfaces 194, 196 can establish a plane that is substantially perpendicular to the major plane P of the panel body 40. With the configuration of FIG. 4C, the leading surface 194 is substantially perpendicular to the major plane P of the panel body 40, whereas the trailing surface 196 establishes a plane that is non-perpendicular with the major plane P. The first rail 152 is sized and shaped commensurate with a size and shape of the first slot 72 (FIG. 4A) of the first interlock structure 42 (FIG. 3), and thus in some embodiments tapers in thickness (i.e., the height direction Y) from the base 190 to the tip 192.

The shoulder 180 and the first rail 152 combine to define the first channel 154. In this regard, extension of the shoulder 180 from the platform 150 defines a side face 200, with the first channel 154 being formed between the first side face 200 of the shoulder 180 and the trailing surface 196 of the first rail 152. The first channel 154 defines an open end 204 and a closed end 206 opposite the open end 204, with a surface of the first channel 154 from the open end 204 to the closed end 206 being substantially perpendicular to the major plane P of the panel body 40 (e.g., within 5 degrees of a truly perpendicular relationship). For example, the side face 200 of the shoulder 180 can establish a plane that is substantially perpendicular to the major plane P of the panel body 40 (it being recalled that it in some embodiments, the trialing surface 196 is non-perpendicular to the major plane P). Regardless, the first channel 154 is sized and shaped in accordance with a size and shape of the first finger 70 (FIG. 4A) of the first interlock structure 42 (FIG. 3), and thus in some embodiments tapers in width (i.e., the height direction Y) from the open end 204 to the closed end 206.

Returning to FIG. 3, the leg 182 projects rearwardly from the first rail 152 (away from the panel body 40 in the depth direction Z) to further space the second rail 156 and the bracket 184 away from the rear major face 52. With additional reference to FIG. 4D, the second rail 156 is connected to a side face 210 of the leg 182 by a head 212 such that the second rail 156 is laterally offset from the leg 182 in the height direction Y. The second rail 156 extends from a base 214, formed at an intersection with the head 212 to a tip 216. In this regard, extension of the second rail 156 from the base 214 is generally in the depth direction Z (toward the panel body 40) and includes a surface that is substantially perpendicular (e.g., within 5 degrees of a truly perpendicular relationship) to the major plane P of the panel body 40. Stated otherwise, extension of the second rail 156 from the base 214 to the tip 216 forms leading and trailing surfaces 218, 220; at least one of the surfaces 218, 220 establishes a plane that is substantially perpendicular to the major plane P of the panel body 40. The second rail 156 is sized and shaped in accordance with a size and shape of the second slot 76 (FIG. 4B) of the first interlock structure 42 (FIG. 2) and thus can taper in thickness (i.e., the height direction Y) from the base 214 to the tip 216. With the configuration of FIG. 4D, the leading surface 218 is substantially perpendicular to the major plane P, whereas the trailing surface 220 is arranged at an angle that is non-perpendicular relative to the major plane P, thus establishing the tapered shape.

The leg 182 and the second rail 156 combine to define the second channel 158, for example as a spacing between the side face 210 of the leg 182 and the trailing surface 220 of the second rail 156. The second channel 158 extends from an open end 230 to a closed end 232 and includes at least one surface that is substantially perpendicular (e.g., within 5 degrees of a truly perpendicular relationship) to the major plane P of the panel body 40. For example, the outer surface 210 of the leg 182 at least along the second channel 158 can establish a plane that is substantially perpendicular to the major plane P of the panel body 40. The second channel 158 is sized and shaped in accordance with a size and shape of the second finger 74 (FIG. 4B) of the first interlock structure 42 and thus can taper in width (i.e., the height direction Y) from the open end 230 to the closed end 232, for example by the non-perpendicular arrangement of the trailing surface 220 relative to the major plane P as described above.

The clip assembly anchor 184 can assume a variety of forms, and in some embodiments is identical to the clip assembly anchor 102 (FIG. 3) of the first interlock structure 42 (FIG. 3) and thus is configured for engagement with clip assemblies conventionally employed for mounting guide signs to an I-beam. Thus, the clip assembly anchor 184 can include opposing, first and second bracket segments 240, 242 that define a trough 244 configured for assembly to an I-beam (for example by bolts or other clip assembly components captured within the trough 244).

Returning to FIG. 2, the complimentary constructions of the first and second interlock structures 42, 44 facilitate robust assembly between two adjacent panels 22. For example, FIG. 5A illustrates mated engagement between first and second panels 22a, 22b, and in particular between the first interlock structure 42a of the first panel 22a and the second interlock structure 44b of the second panel 22b. The first finger 70a of the first panel 22a is captured within the first channel 154b of the second panel 22b, and the first rail 152b of the second panel 22b is captured within the first slot 72a of the first panel 22a. Similarly, the second finger 74a of the first panel 22a is captured within the second channel 158b of the second panel 22b, and the second rail 156b of the second panel 22b is captured within the second slot 76a of the first panel 22a. An interlocked joint 250 (referenced generally) is established by the interface between the first and second interlock structures 42a, 44b. For example, the corresponding taper angles established along the trailing surface 92a of the first finger 70a and the trailing surface 196b of the first rail 152b forces the first finger 70a and the first rail 152b into frictional engagement within the first slot 72a, and the first channel 154b, respectively. The leading surface 90a of the first finger 70a bears against and is forced into frictional engagement with the first side face 200b of the shoulder 180b (recalling that in some embodiments the leading surface 90a and the first side face 200b are both substantially perpendicular to the major plane P of the corresponding panel body 40a, 40b, and thus are arranged substantially parallel with one another); similarly, the leading surface 194b of the first rail 152b bears against and is forced into frictional engagement with the first side face 104a of the leg 100a (recalling that in some embodiments, the leading surface 194b and the first side face 104a are both substantially perpendicular to the major plane P of the corresponding panel body 40a, 40b, and thus are arranged substantially parallel with one another). A similar, interlocked engagement is established at the second finger 74a and the second rail 156b.

In the assembled state of FIG. 5A, the front major face 50a, 50b of the panel bodies 40a, 40b are substantially aligned or substantially parallel (e.g., within 5 degrees of a truly parallel relationship). The first side 54a of the first panel body 40a is immediately adjacent the second side 56b of the second panel body 40b. More particularly, the overhang 80a of the first panel 22a extends over the platform 150b of the second panel 22b. As shown, a gap G exists between the rear major face 52a of the overhang 80a and the exterior surface 170b of the platform 150b for reasons made clear below. The interlocked joint 250 described above serves to robustly prevent movement of the first and second panels 22a, 22b relative to one another in multiple directions or planes. For example, the first and second panels 22a, 22b cannot rotate relative to one another, nor can the panels 22a, 22b move relative to one another in the height direction Y. Movement of the panels 22a, 22b relative to one another in depth direction Z is also limited; relative to the orientation of FIG. 5A, the first panel 22a cannot move leftward relative to the second panel 22b (and the second panel 22b cannot move rightward relative to the first panel 22a). While it is possible to force the first and second panels 22a, 22b away from one another in the depth direction Z (to disassemble the panels 22a, 22b), a substantive force is required to overcome the frictional lock. Notably, the interlocked joint 250 between the panels 22a, 22b is provided without the use or installation of separate or additional mechanical fasteners (e.g., stitch bolts). Finally, while the interlocked joint 250 may permit movement of the panels 22a, 22b relative to one another in the length direction X (e.g., into a plane of the page of FIG. 5A), the adhesive-based fastener 24 (FIG. 1A) is utilized to prevent this movement from occurring as described below.

In addition to the interlocked joint 250, the interlock structures 42, 44 in accordance with some embodiments of the present disclosure are configured to facilitate assembly between the two panels 22a, 22b via a motion that is substantially perpendicular to the exterior surface 170 of the platform 150. For example, FIG. 5B illustrates the second panel 22b slightly spaced from the first panel 22a, with the first interlock structure 42a poised for engagement with the second interlock structure 44b. The first finger 70a is aligned with the first channel 154b, the second finger 74a is aligned with the second channel 158b, the first rail 152b is aligned with the first slot 72a and the second rail 156b is aligned with the second slot 76a. Movement of the first and second panels 22a, 22b toward one another in the depth direction Z that is otherwise substantially perpendicular to the platform exterior surface 170b (e.g., within 5 degrees of a truly perpendicular relationship) transitions the panels 22a, 22b to the assembled state of FIG. 5A and establishes the interlocked joint 250. For example, the parallel, flat interface between the leading surface 124a of the second finger 74a and the side face 210b of the leg 182b maintains the desired orientation of the panels 22a, 22b relative to one another, with the leading surface 124a sliding along the side face 210b (and vice-versa) in guiding the interlock structures 42a, 44b into engagement. For reasons made clear below, this motion (e.g., substantially perpendicular to the platform exterior surface 170b) facilitates ease of assembly in the presence of the adhesive-based fastener 24 (FIG. 1A).

The complimentary interlock structures 42, 44 described above are but one example of a self-locking joint configuration envisioned by the present disclosure. Other interlock constructions capable of providing the interlocked joint upon muted engagement (and without requiring separate mechanical fasteners such as stitch bolts) can be employed. For example, in other embodiments the second finger 74, the second slot 76, the second rail 156, and/or the second channel 158 can be omitted.

Returning to FIG. 1A, the adhesive-based fasteners 24 are configured to be adhesively secured between adjacent ones of the panels 22 and can assume a variety of forms. In some embodiments, and as shown in FIG. 6, the adhesive-based fasteners 24 can be double-sided tape strips, including a core or backing 260 (e.g., foam or film) carrying or maintaining opposing adhesive layers 262, 264. The adhesive layers 262, 264 each comprise an adhesive, such as an epoxy, transfer adhesive, acrylic adhesive, pressure sensitive adhesive, or removable adhesive. In some embodiments, the adhesive-based fastener 24 can be a double-sided 3M VHB acrylic foam tape (e.g., 3M VHB 4956F) available from 3M Company, St. Paul, Minn. One or both of the adhesive layers 262, 264 can be covered with a release liner 266, 268, as is known in the art.

Regardless of an exact construction, the first and interlock structures 42, 44 are configured in accordance with a size and shape of the adhesive-based fasteners as reflect by FIG. 7A. In particular, FIG. 7A illustrates the assembled state of the first and second panels 22a, 22b as described above with respect to FIG. 5A, along with one of the adhesive-based fasteners 24 interposed there between. The adhesive-based fastener 24 is located within the gap G (FIG. 5A), and is arranged such the first adhesive layer 262 (FIG. 6) is adhesively secured to the exterior surface 170b of the platform 150b, and the second adhesive layer 264 (FIG. 6) is adhesively secured to the rear major face 52a of the panel body overhang 80a. The so-applied adhesive-based fastener 24 thus impedes sliding movement of the first panel 22a relative to the second panel 22b in the length direction X (i.e., into and out of the plane of the page of FIG. 7A) as well as in the depth direction Z (i.e., prevents the panels 22a, 22b from separating away from one another). Notably, relative to the upright orientation of FIG. 7A, the adhesive-based fastener 24 does not constitute a load bearing component of the interlocked joint 250. That is to say, the complimentary first and second interlock structures 42a, 44b establish robust engagement at the interlocked joint 250 with or without the adhesive-based fastener 24. The adhesive-based fastener 24 more simply impedes the sliding movement as described above, and optionally forms a partial seal at a seam 270 between the panel bodies 40a, 40b. Furthermore, upon final installation, each assembled panel 22 will likely be attached to an installation site support structure (e.g., an I-beam) with a bolt or a clip that not only maintains the panels 22 upright, but also acts to carry the load and further impede the sliding motion in the depth direction Z.

Straight forward assembly of the first and second panels 22a, 22b in the presence of the adhesive-based fastener 24 can be described with reference to FIG. 7B that otherwise reflects the slight panel-to-panel spacing of FIG. 5B, but with the adhesive-based fastener 24 adhesively secured to the platform exterior surface 170b. As shown, the panels 22a, 22b are in highly close proximity to one another, and the second adhesive layer 264 is exposed. However, the first panel 22a is not in contact with, and thus is not adhesively secured to, the second adhesive layer 264. In some embodiments, the adhesive-based fastener 24 is rectangular, such that the second adhesive layer 264 is substantially parallel with the first adhesive layer 262. Because the first adhesive layer 262 is secured to the platform exterior surface 170b, then, the second adhesive layer 264 is substantially parallel with the exterior surface 170b (e.g., within 5 degrees of a truly parallel relationship). Recalling the interlock structure assembly technique or motion in which the first panel 22a is moved relative to the second panel 22b in a direction substantially perpendicular to the exterior surface 170b, as the first and second panels 22a, 22b are moved to bring the first and second interlock structures 42a, 44b into locked engagement, the rear major face 52a of the overhang 80a will intimately and simultaneously contact a substantial surface area of the second adhesive layer 264, resulting in the arrangement of FIG. 7A. The interlock structures 42a, 44b are thus configured such that in achieving mated engagement there between, the rear major face 52a of the overhang 80a is held substantially parallel to the second adhesive layer 264 and is maneuvered in a direction that is substantially parallel to the rear major face 52a and the second adhesive layer 264 to better ensure complete contact, and thus adhesive securement, at an interface of the rear major face 52a and the second adhesive layer 264. Further, interface between the rear major face 52a of the overhang 80a and the exposed adhesive layer 264 is designed to be the last point of contact during movement of the panels 22a, 22b in establishing complete engagement of the interlocking joint 250, allowing for repositioning of the panels 22a, 22b in the length direction X to achieve end edge alignment.

With the above explanations of panel-to-panel mounting in mind, the indicia 26 of FIG. 1C can be provided in a variety of formats. In general terms, the sign user (e.g., a government agency) creates a sign design and sends the sign design to a sign manufacturer. The sign design dictates the number, shape, and size of the panels 22 to be used in creating a particular sign. With this in mind, FIG. 1B illustrates one example sign design in which four of the panels 22a-22d are assembled to one another as described above, with the front major faces 50a-50d of the corresponding panel bodies 40a-40d uncovered in defining the sign blank 28. Prior to application of the indicia 26 (and in some embodiments prior to mounting the panels 22a-22d to one another), an optically active sheeting 300 can be applied to the front major face 50 of each panel 22 as shown in FIG. 8A. The optically active sheeting 300 can be reflective or retroreflective. Two known types of retroreflective sheeting are microsphere-based sheeting and cube corner sheeting. Exemplary optically active sheeting includes any of the prismatic and beaded sheeting products manufactured by 3M Company of St. Paul, Minn. The optically active sheeting 300 encompasses an entirety of the front major face 50, extending to and between the opposing sides 54, 56. The optically active sheeting 300 terminates at the second side 56 (i.e., does not extend to the platform 150). FIG. 8A further reflects that prior to assembly of the panel 22 to another panel 22, the adhesive-based fastener 24 can be applied to the platform 150, with the lip 174 serving as a guide or stop for placement of the adhesive-based fastener 24. In some embodiments of the present disclosure, the panel 22, the applied adhesive-based fastener 24, and the applied optically active sheeting 300 can collectively be referred to as a panel assembly 302, with FIG. 8B illustrating an arrangement of four of the panel assemblies 302a-302d (as a point of reference, the arrangement of FIG. 8B is essentially identical to that of FIG. 1B, except that optically active sheeting 300 has been applied to the panels 22a-22d).

Indicia (letters, numbers, symbols, images, etc.) can be prepared in accordance with the sign design and applied to the panel assemblies 302 in various manners. For example, the indicia can be individually cut from a sheet of material (e.g., optically active material of a color differing from that of the optically active sheeting 300), can collectively be printed onto a single sheet of material, or portions of the desired indicia can be printed on to separate sheets of material. In yet other embodiments, the indicia (or portions thereof) can be directly printed (e.g., screen printed) on to the optically active sheeting 300 before or after application of the optically active sheeting 300 to the corresponding panel 22. In yet other embodiments, the indicia can be generated by cutting indicia characters in translucent color overlay film and then applying over white retroreflective sheeting to expose the indicia in white color and the background color of the overlay film.

With any of the indicia formats described above, with some multi-panel sign manufacturing methods of the present disclosure, the panel assemblies 302 are mounted to one another, and the adhesive-based fastener 24 interposed between adjacent panel assemblies 302 is adhesively secured to both of the corresponding panels 22 (i.e., the arrangement of FIG. 7B), at the time the indicia is applied. Thus, in the arrangement of FIG. 8B, the panel assemblies 302a-302d are not only mounted to one another at the interlocked joint 250, but are prevented from sliding relative to one another in the length direction X and further prevented from movement relative to one another in the depth direction Z in a manner that might otherwise cause disengagement of the interlocked joint 250. One example of possible indicia with a completed sign 330 is shown in FIG. 8C. Indicia item identified at 340 extends across two of the panel assemblies 302b, 302c, and thus can be designated as comprising indicia segments 342, 344. In the exemplary embodiment shown, the indicia segments 342, 344 are separated from one another along the seam 270 (e.g., the indicia item 340 is cut before or after application to the panel assemblies 302a-302d; the segments 342, 344 are separately prepared and applied; etc.). The indicia segments 342, 344 are registered relative to one another to visually create the collective indicia item 340. The completed sign 330 can then be delivered to an installation site. During transport and installation of the sign 330, the panel assemblies 302a-302d remain mounted to one another at the corresponding interlocked joints 250, and do not shift or slide relative to one another due to the adhesive-based fasteners 24 (FIG. 7B). Thus, the indicia segments 342, 344 remain aligned or registered. In other indicia formats, the indicia item 340 can be printed on a sheet 360 that in turn is applied across the second and third panel assemblies 302b, 302c as shown in FIG. 8D. Because the panel assemblies 302a-302d are locked and adhered to one another, the panel assemblies 302a-302d will not shift during handling in a manner that might otherwise damage or tear the sheet 360.

Alternative manufacturing techniques entail delivering separated, labeled panel assemblies 302 to the installation site for mounting and installation. With this approach, the panel assemblies 302a-302d are again initially mounted to one another, but with the adhesive-based fastener 24 interposed between adjacent ones of the panel assemblies 302a-302d not adhered to both of the corresponding panels 22a-22d as generally reflected in FIGS. 9A and 9B (as a point of reference, FIG. 9A illustrates two of the panel assemblies 302a, 302b). FIG. 9B more clearly illustrates that the release liner 268 has not been removed; thus, the adhesive-based fastener 24 provided with the second panel assembly 302b is not adhesively secured to the panel 22a of the first panel assembly 302a. The panel assemblies 302a-302d are arranged such that the corresponding ends 58, 60 are aligned, and the indicia is then applied as described above and shown in FIG. 9C. Under circumstances where an indicia item 340 extends across two (or more) of the panel assemblies 302a-302d, the indicia item 340 is cut at the corresponding seem 270. The labeled panel assemblies 302a-304d are decoupled from one another as in FIG. 9D, and shipped to the installation site in this disassembled state. The installer then removes the release liner 268 from the adhesive-based fasteners 24, and assembles the sign 330 as in FIG. 8C. In this regard, the installer ensures that the ends 58, 60 are aligned prior to effectuating adhesive securement between adjacent panel assemblies 302a-302d, thus aligning the indicia segments 342, 344 as shown.

Regardless of whether a completed sign is delivered to the installation site, or labeled panel assemblies are assembled at the installation site, the completed sign is mounted at the installation site in accordance with known techniques. For example, FIG. 10A illustrates an exemplary installation scenario in which the completed sign 330 is mounted to two metal posts 400, 402. Conventionally, the posts 400, 402 are I-beams, with FIG. 10B reflecting the use of clip assemblies 404 affixing various ones of the anchors 102, 184 to the post 400.

The multi-panel sign systems and methods of the present disclosure provide a marked improvement over previous designs. The panels of the present disclosure incorporate complimentary interlock structures that facilitate robust engagement between adjacent panels in a manner not requiring the use of separate mechanical fasteners (e.g. stitch bolts). Further, the adhesive-based fasteners provided with systems of the present disclosure impede shifting of panels and prevent disengagement of the complimentary interlock structures, thus ensuring that sign indicia will not become misaligned during shipping.

Although the present disclosure has been described with reference to preferred embodiments, workers skilled in the art will recognize that changes can be made in form and detail without departing from the spirit and scope of the present disclosure.

What is claimed is:

1. A multi-panel sign system:
first and second panels each including:
a panel body defining a substantially planar front major face for maintaining signage indicia, the panel defining opposing, first and second sides,
complimentary, first and second interlock structures located adjacent the first and second sides, respectively, the interlock structures each projecting in a direction opposite the front face,
wherein a complimentary configuration of the interlock structures is such that the first interlock structure of the first panel selectively mechanically interlocks with the second interlock structure of the second panel; and
an adhesive-based fastener;
wherein the system is configured to provide a disassembled state in which the first and second panels are separated from one another, and an assembled state in which:
the first interlock structure of the first panel mechanically locks with the second interlock structure of the second panel to establish an interlocked joint,
the adhesive-based fastener is adhesively bonded to the first and second panels.

2. The system of claim 1, wherein:
the first interlock structure includes a first finger and a first slot; and
the second interlock structure includes a first rail and a first channel;
and further wherein the assembled stated includes the first finger of the first panel captured within the first channel of the second panel, and the first rail of the second panel captured within the first slot of the first panel.

3. The system of claim 2, wherein the panel body further defines a rear major face opposite the front major face, and further wherein the first finger projects from the rear major face of the corresponding panel body.

4. The system of claim 3, wherein projection of the first finger from the corresponding panel body is substantially perpendicular to a major plane of the corresponding panel body.

5. The system of claim 4, wherein the first finger defines a leading surface opposite a trailing surface, and further wherein the trailing surface defines a portion of the first slot.

6. The system of claim 5, wherein the first interlock structure further includes a leg projecting from the rear major face of the corresponding panel body to a location spaced from the first finger, the leg and the corresponding trailing surface combining to define the corresponding first slot.

7. The system of claim 6, wherein the leg defines a first side face facing the corresponding first finger and a second side face opposite the first side face, and further wherein at least one of the first side face and the trailing surface projects from the rear major face of the corresponding panel body at an angle that is non-perpendicular to the major plane of the corresponding panel body.

8. The system of claim 3, wherein the first finger is laterally offset from the first side of the corresponding panel body in a direction of the corresponding second side.

9. The system of claim 3, wherein the second interlock structure further includes:
a platform extending from the panel body, the platform defining an exterior surface facing, and offset from, the front major face of the corresponding panel body, and an interior surface opposite the exterior surface;
wherein the first channel extends from an open end adjacent the exterior surface to a closed end opposite the open end in a direction away from the exterior surface.

10. The system of claim 9, wherein the exterior surface of the platform defines a plane substantially parallel with a major plane of the corresponding panel body.

11. The system of claim 10, wherein the adhesive-based fastener is adhered to the exterior surface.

12. The system of claim 10, wherein the platform extends beyond the second side of the panel body of the corresponding panel in a direction opposite the first side, and further wherein the assembled state includes a portion of the panel body of the first panel overlying the exterior surface of the platform of the second panel.

13. The system of claim 12, wherein the assembled state include the first side of the panel body of the first panel aligned with the second side of the panel body of the second panel.

14. The system of claim 12, wherein the assembled state include the adhesive-based fastener adhesively secured to the exterior surface of the platform of the second panel and a rear major face of the panel body of the first panel.

15. The system of claim 14, wherein the adhesive-based fastener defines a major plane, and further wherein the assembled state includes the major plane of the adhesive-based fastener arranged substantially parallel with a major plane of the panel body of the first panel and with the exterior face of the platform of the second panel.

16. The system of claim 2, wherein:
the first interlock structure includes a second finger and a second slot; and
the second interlock structure includes a second rail and a second channel;
and further wherein the assembled state include the second finger of the first panel captured within the second channel of the second panel, and the second rail of the second panel captured within the second slot of the first panel.

17. The system of claim 16, wherein each of the fingers and the rails includes a base opposite a free end and defines a direction of extension from the corresponding base to the corresponding free end, and further wherein the direction of extension of the first and second fingers is away from the front major face of the corresponding panel body, and the direction of the extension of the first and second rails is toward the front major face of the corresponding panel body.

18. The system of claim 1, wherein each of the panels is extruded aluminum.

19. The system of claim 1, wherein the adhesive-based fastener is a double-sided foam tape.

20. The system of claim 1, further comprising:
a first optically active sheeting applied to the front major face of the first panel; and
a second optically active sheeting applied to the front major face of the second panel.

21. The system of claim 20, further comprising:
a first indicia segment formed on the first optically active sheeting; and
a second indicia segment formed on the second optically active sheeting;
wherein the assembled state includes the first indicia segment registered with the second indicia segment to collectively form an indicia item across the first and second panels.

22. The system of claim 1, wherein the assembled stated includes the interlocked joint preventing rotation of the first panel relative to the second panel, and the adhesive-based fastener preventing sliding of the first panel relative to the second panel.

23. The system of claim 22, further comprising:
a sign overlay secured to the front face, the sign overlay including a carrier substrate selected from the group consisting of aluminum and plastic, optically active sheeting laminated to the carrier substrate, and indicia formed on the optically active sheeting.

24. The system of claim 22, wherein the adhesive-based fastener further prevents disengagement of the first interlock structure of the first panel from the second interlock structure of the second panel in the assembled state.

25. A method of preparing a multi-panel sign, the method comprising:
receiving first and second panels each including:
a panel body defining a substantially planar front major face for maintaining signage indicia, the panel defining opposing, first and second sides,
complimentary, first and second interlock structures located adjacent the first and second sides, respectively, the interlock structures each projecting in a direction opposite the front major face;
interlocking the first and second panels, including the first interlock structure of the first panel mechanically engaged with the second interlock structure of the second panel, and an adhesive-based fastener adhesively bonded to the first and second panels such that the adhesive-based fastener impedes sliding of the first panel relative to the second panel;
disposing a first indicia segment over the front major face of the first panel;
disposing a second indicia segment over the front major face of the second panel; and
wherein the first indicia segment is registered with the second indicia segment to collectively from an indicia item;
and further wherein the interlocked first and second panels are constrained from movement relative to one another to maintain the indicia item.

26. The method of claim 25, wherein the step of interlocking the first and second panels includes:
applying the adhesive-based fastener to the second panel;
aligning the first interlock structure of the first panel with the second interlock structure of the second panel such that first panel does not contact the adhesive-based fastener; and
moving the first and second panels toward one another to bring the first panel into contact with the adhesive-based fastener and engage the first interlock structure of the first panel with the second interlock structure of the second panel.
